(19) United States
(12) Patent Application Publication
(10) Pub. No.: US 2021/0351551 A1
(43) Pub. Date: Nov. 11, 2021

(54) USB CONNECTOR COMBINATION WITH CIRCUIT PROTECTIVE DEVICE

(71) Applicant: Oxti Corporation, Taipei (TW)

(72) Inventor: Chih Feng HO, Taipei (TW)

(21) Appl. No.: 16/869,838

(22) Filed: May 8, 2020

(51) Int. Cl. H01R 31/06; H01R 13/518; H01R 13/60; H01R 13/66

(52) U.S. Cl. CPC H01R 31/065; H01R 13/518; H01R 13/631; H01R 13/6641; H01R 13/60

(57) ABSTRACT

A USB connector combination includes a connector selected from type A and engaged in a housing and having a power terminal, an adapter selected from type C and engaged in the housing and electrically connected to the connector, and the adapter includes a power conductor, and a diode includes an anode connected to the power terminal of the connector, and a cathode connected to the power conductor of the adapter. The housing includes a chamber for receiving and engaging with the connector, and a compartment for receiving and engaging with the adapter. The housing includes a partition formed between the chamber and the compartment of the housing.

### BACKGROUND OF THE INVENTION

### 1. Field of the Invention

The present invention relates to a universal serial bus (USB) connector combination, and more particularly to a USB connector combination including a circuit protective device connected or coupled between two connectors of different types for protecting the electrical apparatuses or facilities and for preventing the electrical apparatuses or facilities from being damaged through the USB connector combination inadvertently while in use.

### 2. Description of the Prior Art

Typical universal serial bus (USB) connectors comprise a wire or cable, and one or more terminals or conductors or plugs attached or mounted or secured or coupled to the cable for connecting or coupling to various electrical apparatuses or facilities, such as personal computers, notebooks, docks, discs, mobile phones, portable phones, batteries, chargers, power suppliers, etc., and the plugs are selected from type A, type B, type C, or the like for connecting or coupling to the selected or predetermined or required electrical apparatuses or facilities.

For example, the type A terminals or conductors or plugs may be provided for connecting or coupling to the personal computers, notebooks or the like, and the type C terminals or conductors or plugs may be provided for connecting or coupling to the docks, discs, mobile phones, portable phones, batteries, chargers, power suppliers, etc., and may not be provided for connecting or coupling to the other or different types of electrical apparatuses or facilities. Normally, two or more different types of terminals or conductors or plugs are required to be provided and carried with the user.

For example, U.S. Pat. No. 9,231,344 B1 to Liao, and U.S. Pat. No. 9,431,746 B2 to Wu et al. disclose two of the typical USB connectors for connecting or coupling to various electrical apparatuses or facilities, but the typical USB connectors may be provided and used for connecting or coupling to only one type of the electrical apparatuses or facilities, but may not be provided for connecting or coupling to the other or different types of electrical apparatuses or facilities.

U.S. Pat. No. 9,270,038 B1 to Chao, U.S. Pat. No. 9,455,528 B1 to Chao, U.S. Pat. No. 9,537,248 to Hung, and U.S. Pat. No. 10,256,585 to Wierenga disclose the other typical USB connectors each comprising two or more terminals or conductors or plugs for connecting or coupling to the other or different types of electrical apparatuses or facilities.

However, the typical USB connectors may comprise two or more wires or cables for connecting or coupling to different types of the terminals or conductors or plugs, and may comprise a large volume and/or a complicated structure or configuration that may not be easily carried with the user. In addition, when the typical USB connectors are used for connecting or coupling the batteries, chargers, power suppliers, etc. to the electrical apparatuses or facilities, such as personal computers, notebooks, docks, discs, mobile phones, portable phones, or the like, the electrical apparatuses or facilities may have a good chance to be over-charged by the batteries, chargers, or power suppliers when the connection between the electrical apparatuses or facilities and the batteries, chargers, or power suppliers has become failure.

The present invention has arisen to mitigate and/or obviate the afore-described disadvantages of the conventional USB connectors or terminals.

### SUMMARY OF THE INVENTION

The primary objective of the present invention is to provide a USB connector combination including a circuit protective device connected or coupled between two connectors of different types for protecting the electrical apparatuses or facilities and for preventing the electrical apparatuses or facilities from being damaged through the USB connector combination inadvertently while in use.

In accordance with one aspect of the invention, there is provided a USB connector combination comprising a housing, a connector selected from type A and engaged in the housing, the connector including a power terminal, an adapter selected from type C and engaged in the housing and electrically connected to the connector, and the adapter including a power conductor, and a diode including an anode connected to the power terminal of the connector, and a cathode connected to the power conductor of the adapter.

The housing includes a chamber formed in a first end portion of the housing for receiving and engaging with the connector, and a compartment formed in a second end portion of the housing for receiving and engaging with the adapter. The housing includes a partition formed between the chamber and the compartment of the housing.

A male plug member may further be provided and engaged with the adapter. The housing includes an extension extended from the housing, and a loop formed on the extension, and a cable engaged with the loop of the extension. The cable includes a female plug member. The housing includes a notch formed in the housing, and the male plug member includes an anchor for engaging with the notch of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating the operation of a USB connector combination in accordance with the present invention;

FIG. 2 is another perspective view of the USB connector combination;

FIG. 3 is a further perspective view similar to FIG. 2, illustrating the operation of the USB connector combination;

FIG. 4 is a partial perspective view of the USB connector combination;

FIG. 5 is a partial exploded view of the USB connector combination; and

FIG. 6 is a block diagram illustrating the arrangement of two connectors of different types of the USB connector combination.

### DETAILED DESCRIPTION OF THE PREFERRED EMBODIMENT

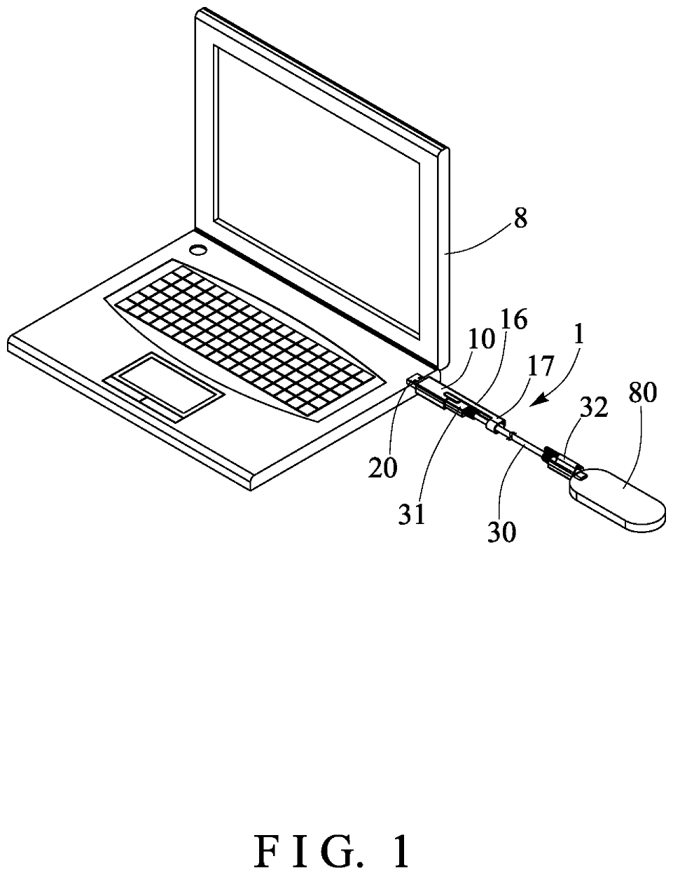

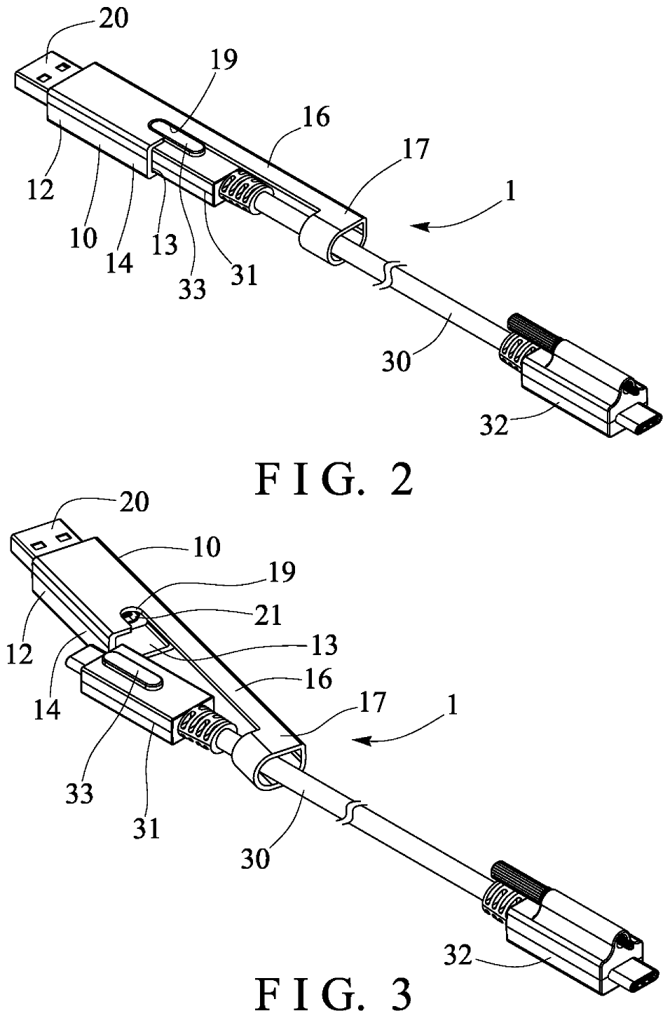

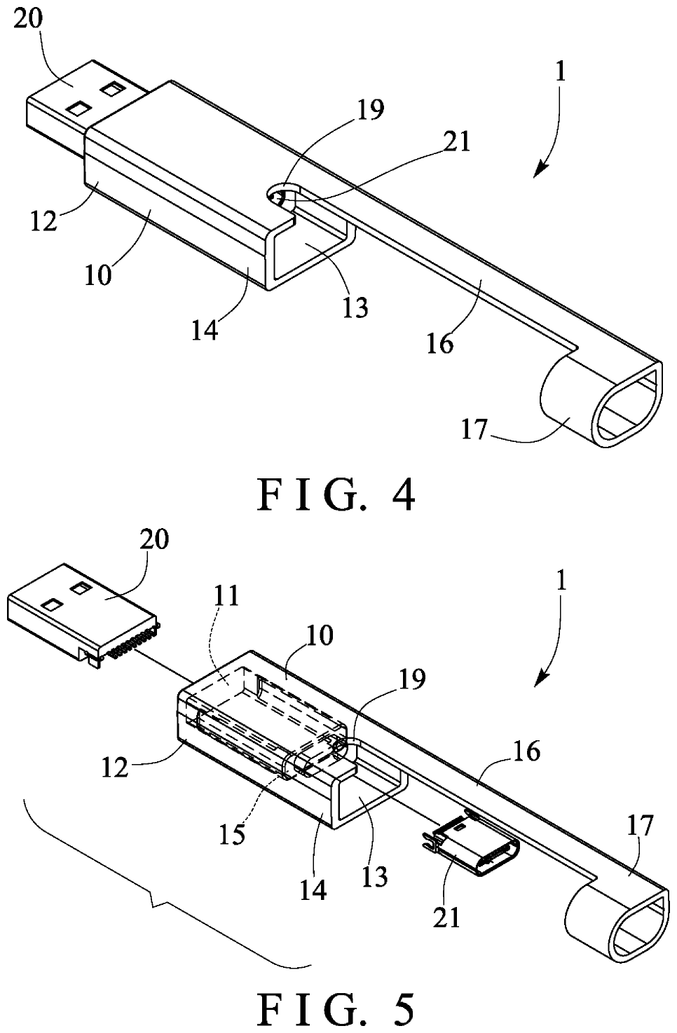

Referring to the drawings, and initially to FIG. 1, a USB connector assembly or combination 1 in accordance with the present invention is provided for coupling between various electrical apparatuses or facilities 8, 80, such as personal computers, docks, discs, mobile phones, portable phones, notebooks 8, and batteries, chargers, power suppliers 80, etc., as shown in FIGS. 2-5, the USB connector combination 1 comprises a receptacle or housing 10 including a compartment or chamber 11 formed in one or first end portion 12 thereof, and a chamber or compartment 13 formed in the other or second end portion 14 thereof, and separated from each other with a partition 15 and/or communicating with each other, for receiving or engaging with a connector 20 and an adapter 21 respectively, in which the connector 20 and the adapter 21 are electrically connected or coupled together or engaged with each other.

It is preferable that the housing 10 further includes an opening or notch 19 formed therein, such as formed in the other or second end portion 14 thereof and communicating with the compartment 13 of the housing 10, a band or extension 16 is extended from the other or second end portion 14 of the housing 10, and a hook or loop 17 is formed or provided on the free end portion of the extension 16 for receiving or engaging with a wire or cable 30 which includes a male plug member 31 and a female plug member 32 attached or mounted or secured or coupled to the end portions of the cable 30. The connector 20 and the adapter 21 may be selected from type A or type B, or type C for connecting or coupling to various electrical apparatuses or facilities 8, 80. For example, the connector 20 may be selected from type A for connecting or coupling to personal computers, docks, discs, mobile phones, portable phones, or notebooks 8 (FIG. 1), and the adapter 21 may be selected from type C for connecting or coupling to batteries, chargers, power suppliers 80, or the like.

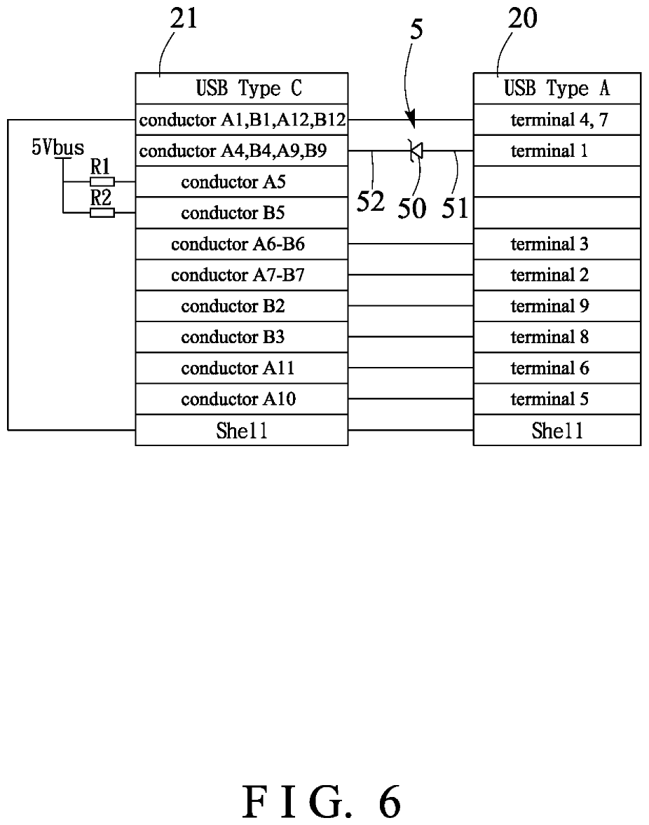

As shown in FIG. 6, the adapter 21 is selected from type C and includes twenty four (24) terminals or conductors for connecting or coupling to the connector 20, for example, the A1, B1, A12, B12 conductors are grounded conductors for electrically connecting or coupling to the 4^{th} and the 7^{th} terminals of the connector 20, the A4, B4, A9, B9 conductors are power conductors for electrically connecting or coupling to the 1^{st} terminal of the connector 20, A6, B6 conductors are positive data or information conductors for electrically connecting or coupling to the relative terminals of the connector 20, A7, B7 are negative data or information conductors, B2 conductor is a positive transmission conductor, B3 conductor is a negative transmission conductor, A11 conductor is a positive reception conductor, A10 is a negative reception conductor, and A5 and B5 conductors are spare conductors.

The connector 20 is selected from type A and includes nine (9) conductors or terminals for connecting or coupling to the adapter 21, for example, the 4^{th} and the 7^{th} terminals are grounded terminals, the 1^{st} terminal is a power terminal, the 3^{rd} terminal is a positive data or information terminal, the 2^{nd} terminal is a negative data or information terminal, the 9^{th} terminal is a positive reception terminal, the 8^{th} terminal is a negative reception terminal, the 6^{th} terminal is a positive transmission terminal, and the 5^{th} terminal is a negative transmission terminal. As also shown in FIG. 6, a circuit protective device 5 may further be provided and disposed or connected or coupled between the connector 20 and the adapter 21, such as the 1^{st} terminal of the connector 20 and the A4, B4, A9, B9 conductors of the adapter 21.

For example, the circuit protective device 5 includes a diode 50 which may be selected from a Schottky Diode or the like and which may include a 5V reverse voltage, and which includes a reverse fast cut-off characteristics, and which includes an anode 51 for electrically connecting or coupling to the 1^{st} terminal of the connector 20, and a cathode 51 for electrically connecting or coupling to the A4, B4, A9, B9 conductors of the adapter 21. It is to be noted that the connector 20 for connecting or coupling to personal computers, docks, discs, mobile phones, portable phones, or notebooks 8 (FIG. 1) normally may accept a voltage of about 5V only, and the batteries, chargers, or power suppliers 80 may supply a voltage of more than 20V, and the diode 50 is provided for allowing a current of about 5V to flow into the notebooks 8 and for preventing the notebooks 8 from being over-charged and damaged through the USB connector combination 1.

In operation, as shown in FIGS. 1-3, the connector 20 may be selected from a male structure or configuration and may be connected or coupled to the personal computers, docks, discs, mobile phones, portable phones, or notebooks 8, and the male plug member 31 may be engaged with the adapter 21 which may be selected from a female structure or configuration, and the female plug member 32 may be provided for electrically connecting or coupling to the batteries, chargers, power suppliers 80, or the like, for allowing the power suppliers 80 to energize the notebooks 8 and the like. As shown in FIGS. 2 and 3, the male plug member 31 may include a protrusion or anchor 33 formed or provided thereon or extended therefrom for selectively engaging with the notch 19 of the housing 10, and for anchoring or retaining or positioning the male plug member 31 to the housing 10.

Accordingly, the USB connector combination in accordance with the present invention includes a circuit protective device connected or coupled between two connectors of different types for protecting the electrical apparatuses or facilities and for preventing the electrical apparatuses or facilities from being damaged through the USB connector combination inadvertently while in use.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A USB connector combination comprising:
a housing,
a connector selected from type A and engaged in said housing, said connector including a power terminal,
an adapter selected from type C and engaged in said housing and electrically connected to said connector, and said adapter including a power conductor, and
a diode including an anode connected to said power terminal of said connector, and a cathode connected to said power conductor of said adapter.

2. The USB connector as claimed in claim 1, wherein said housing includes a chamber formed in a first end portion of said housing for receiving and engaging with said connector, and a compartment formed in a second end portion of said housing for receiving and engaging with said adapter.

3. The USB connector as claimed in claim 2, wherein said housing includes a partition formed between said chamber and said compartment of said housing.

4. The USB connector as claimed in claim 1 further comprising a male plug member engaged with said adapter.

5. The USB connector as claimed in claim 4, wherein said housing includes an extension extended from said housing, and a loop formed on said extension, and a cable engaged with said loop of said extension.

6. The USB connector as claimed in claim 5, wherein said cable includes a female plug member.

7. The USB connector as claimed in claim 4, wherein said housing includes a notch formed in said housing, and said male plug member includes an anchor for engaging with said notch of said housing.
